(19) United States
(12) Patent Application Publication
(10) Pub. No.: US 2006/0023935 A1
(43) Pub. Date: Feb. 2, 2006

(54) Printed circuit substrate appearance inspection method, printed circuit substrate appearance inspection program and printed circuit substrate appearance inspection apparatus

(75) Inventor: Akihiro Wakabayashi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 10/986,953

(22) Filed: Nov. 15, 2004

(30) Foreign Application Priority Data
Jul. 30, 2004 (JP) 2004-223927

(51) Int. Cl. G06K 9/00

(52) U.S. Cl. 382/147

(57) ABSTRACT

A printed circuit substrate appearance inspection method comprising: an inspection area defining step defining a predetermined inspection area on an image of a printed circuit substrate including a component mounted on the printed circuit substrate; and an appearance inspection step carrying out appearance inspection of the component by analyzing image data in the thus-defined inspection area, wherein: the inspection area defining step comprises the steps of; detecting a printed substrate pattern part around the component on the printed circuit substrate; and defining the predetermined inspection without overlapping with the thus-detected printed substrate pattern part.

### BACKGROUND OF THE INVENTION

1. Field of the Invention

The present invention relates to a printed circuit substrate appearance inspection method, a printed circuit substrate appearance inspection program and a printed circuit substrate appearance inspection apparatus, and, in particular, to a printed circuit substrate appearance inspection method, a printed circuit substrate appearance inspection program and a printed circuit substrate appearance inspection apparatus advantageous in particular for a printed circuit substrate having a printed substrate pattern part such as a silkscreen printed part.

2. Description of the Related Art

Inspection of respective electronic components mounted on a printed circuit substrate carried out before shipping the circuit substrate which will be then used in an electronic apparatus or such, includes a verification as to whether or not predetermined electronic components are positively mounted, whether or not the mounted positions thereof are proper, whether or not soldering connections between electrodes of the electronic components and lands of electrically conductive patterns provided on the printed circuit substrate are proper, or such. Upon carrying out these verification operations, for reasons that these particular electronic components are very small (on the order of point millimeters, for example); it is necessary to carry out the verification operations on many of these products within a limited duration or such, it may be difficult or it may not be suitable to carry out these inspection operations visually with the naked eyes of a human being directly. Therefore, a method is demanded for taking a photograph of a to-be-inspected printed circuit substrate by a camera or such first and analyzing the thus-obtained image in analytic processing with the use of a computer program so as to carry out these inspection operations efficiently.

FIG. 1 shows a magnified view of one example of such a to-be-inspected printed circuit substrate. Further, FIG. 2 illustrates a part of FIG. 1 in an easily understandable manner. As shown, an electronic component including a component body and electrodes are mounted on the printed circuit substrate on which electrically conductive patterns (indicated in the figures as PATTERN) and lands are previously printed. As a result of the electrodes and the lands of the electrically conductive patterns being soldered (indicated in the figures as SOLDER) together, both are electrically connected together, and also, the electronic component having the electrodes are fixedly mounted on the printed circuit substrate. It is noted that, although the lands are actually provided under the soldering connections on the printed circuit substrate, they do not appear in FIGS. 1 and 2 since the solder actually extends over so as to cover them.

For example, Japanese Laid-open Patent Application No. 2003-110298 discloses a technology concerning a mounted component inspection apparatus for carrying out inspection for verifying as to whether there is not a positional error of electronic components mounted on a printed circuit substrate. According to the technology, for an electronic component having a body part and an electrode part, comparison processing is carried out on an image of the substrate on which the electronic component is mounted, with the use of a matching plate extracted from the image, in particular, from an edge part of the electrode part except a boundary line between the body part and the electrode part. Thereby, inspection for verifying as to whether the components are actually mounted, whether there is no erroneous mounting, and whether the components are mounted in a proper manner, is carried out.

Japanese Laid-open Patent Application No. 63-229577 discloses a technology in which, upon obtaining edge information of objects for the purpose of obtaining shape information of the objects having cross-sectional shapes configuring a latex grain aggregate, a fiber aggregate or such, noise information present in a background of the objects is positively removed so as to improve the preciseness and the processing speed of the edge detection processing.

Japanese Laid-open Patent Application No. 2003-246165 discloses a technology relating to appearance inspection for a mirror surface member or such directed to the improvement in the accuracy and the speed of component edge detection processing even when much noise is included therein, upon extracting an inspection target from an area of an image including a to-be-inspected object.

### SUMMARY OF THE INVENTION

As shown in FIG. 2, on the printed circuit substrate, silkscreen printed parts 210 are provided. They may be simply referred to as ‘silks’, and may be previously produced on a printed circuit substrate by a well-known silkscreen printing technology, for the purpose of indicating positions at which electronic components will be mounted, or, a marker indicating a polarity of an electronic component to be mounted, or such.

A position or a size of the silkscreen printed part may vary due to printing error or such. However, since the object of the silkscreen printed part is to merely indicate an approximate position at which an electronic component is to be mounted or such, a positional accuracy thereof is not strictly required in general. Even if a position, a size or such of the silkscreen printed part is deviated from an originally determined one to the some extent, no substantial problem occurs in a functional view as long as the electronic component is actually mounted at a precise position, finally.

However, when various sorts of inspections are carried out as a result of carrying out information processing on an image obtained from taking a photograph of a printed circuit substrate regarded as a to-be-inspected product during appearance inspection of the printed circuit substrate as mentioned above, the following problems may occur.

FIGS. 3A and 3B will be used to illustrate the problem. These figures show states in which an electronic component 100 is already mounted on a printed circuit substrate, and appearance inspection will be carried out thereon before shipment thereof.

As shown, electrodes 110 of the electronic component 100 are soldered to lands 200 previously provided on the printed circuit substrate so that they are eclectically connected together and also, the electronic component 100 is fixed on the printed circuit substrate. As mentioned above, when appearance inspection is carried out on the electronic component 100, first it is photographed, and then, an inspection window W1 is set in the thus-obtained image, as shown. Thereby, a predetermined inspection area is defined (see FIG. 3A). Then, the image data within the predetermined inspection area thus defined by the inspection window W1 is made to undergo image processing or such. As a result, it is determined whether or not electric connection between the electrodes and the lands included in the inspection area is finished satisfactorily.

However, if a possible printing positional error results in an actual printed position of the silkscreen printed part 210 (top-left ones) too approximate to the position at which the electronic component 100 itself is mounted, as shown in FIG. 3B, the above-mentioned inspection area defined by the inspection window W1 may include the silkscreen printed part 210. In such a case, the silkscreen printed part 210 may be erroneously recognized as the land 200 during image processing carried out so as to analyze the image data of the inspection area as mentioned above by means a computer or such. If such erroneous recognition occurs, data analysis may not be carried out properly, and thus, inspection accuracy of the appearance inspection carried out on the electronic component 100 mounted on the printed circuit substrate may be degraded.

The present invention has been devised in consideration of the above-mentioned problem, and an object of the present invention is to provide a scheme by which, when appearance inspection is carried out on an electronic component mounted on a printed circuit substrate on which a printed circuit pattern part such as a silkscreen printed part is formed, it is possible to avoid degradation of inspection accuracy otherwise occurring due to the presence of the printed substrate pattern part as mentioned above.

According to the present invention, when an inspection area is defined, a printed substrate pattern part around a component on a printed circuit substrate is detected, and the inspection area is defined without overlapping with the thus-detected printed substrate pattern part. Thus, according to the present invention, the inspection area is defined in such a manner previously that no printed substrate pattern part may be included in the inspection area.

In this scheme according to the present invention, since the inspection area is defined in such a manner that no printed substrate pattern part may be included in the inspection area, it is possible to effectively avoid a situation that the printed substrate pattern may degrade the appearance inspection accuracy.

### BRIEF DESCRIPTION OF THE DRAWINGS

FIG. 1 shows a configuration in which electronic components are mounted on a printed circuit substrate;

FIG. 2 illustrates a part of FIG. 1 in an easily understandable manner;

FIGS. 3A and 3B are those used to illustrate a problem which may occur in the related art;

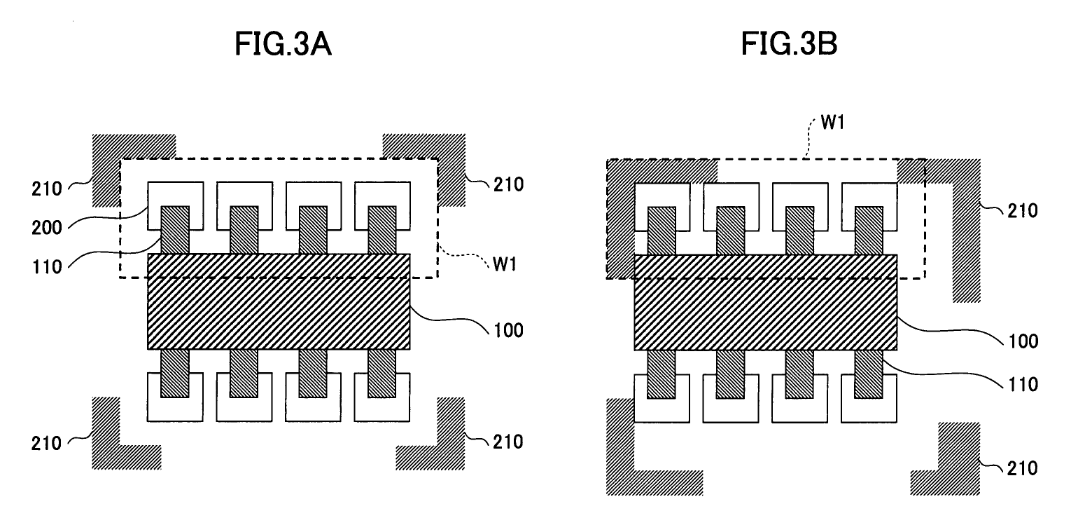

FIG. 4 shows a flow chart of operation according to an embodiment of the present invention;

FIG. 5 is one used to illustrate the flow chart shown in FIG. 4;

FIG. 6 shows a processing flow chart illustrating a printed circuit substrate appearance inspection method according to an embodiment of the present invention;

FIG. 7 shows a block diagram of one example of a printed circuit substrate appearance inspection apparatus according to an embodiment of the present invention;

FIG. 8 shows a flow chart illustrating operations of an embodiment of the present invention in further detail; and

FIGS. 9A and 9B illustrate operations shown in FIG. 8.

### DETAILED DESCRIPTION OF THE PREFERRED EMBODIMENTS

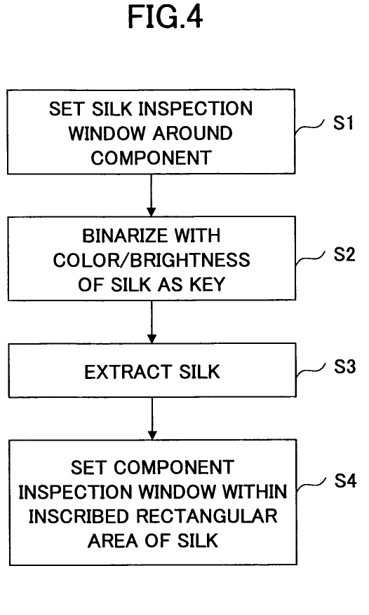

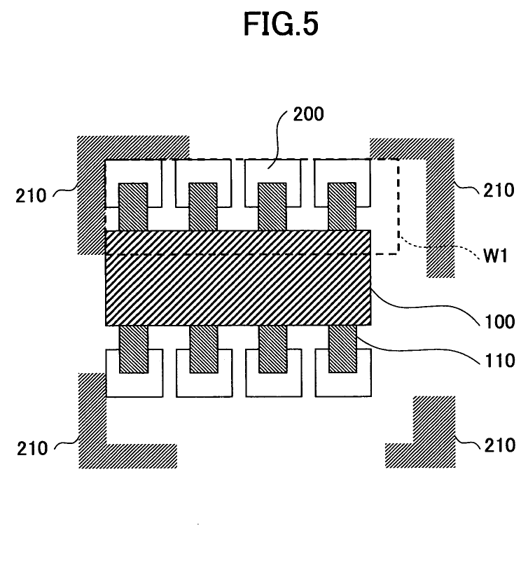

With reference to FIGS. 4 and 5, an embodiment of the present invention is described below.

According to the embodiment of the present invention, as one example of a printed substrate pattern part described below, a silkscreen printed part is applied.

FIG. 4 is a flow chart showing a method of setting a component inspection window for carrying out appearance inspection on an electronic component mounted on a printed circuit substrate according to the embodiment of the present invention.

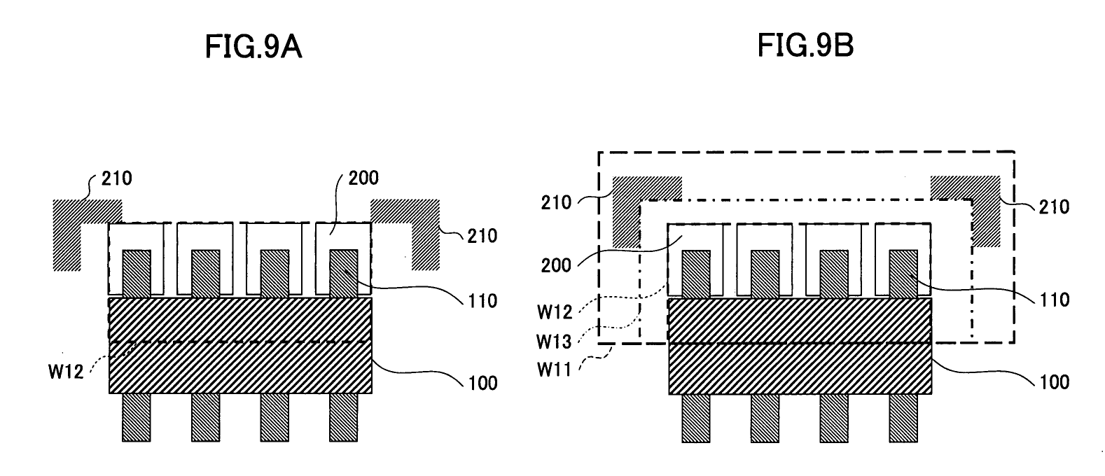

In Step S1, first, a silk inspection window is set around a relevant electronic component 100. This silk inspection window is set in such a manner as to define an area around the relevant electronic component 100, which is an area around electrodes 110 of the electronic component 100 and lands 200 on the printed circuit substrate to which lands the electrodes 110 are soldered. However, the area defined by the silk inspection window is defined in such a manner that it does not include these electrodes 110 and the lands 200 themselves. Specifically, the area is such as that, as shown in FIG. 9B for example, defined by a window W11 avoiding an area defined by a window W12, which will be described later,

In Step S2, after that, based on data of color and/or brightness of the silkscreen printed part previously registered, image data defined by the above-mentioned silk inspection window is binarized. Specifically, first, color and/or brightness data of the silkscreen printed part previously obtained by means of measurement or such is analyzed. Thereby, a range of image data of the silkscreen printed part concerning color and/or brightness obtained when the silkscreen printed part printed on the printed circuit substrate is actually photographed is obtained. In other words, the range of the image data value which the silkscreen printed part may have is obtained. Then, from the value which corresponds to the outer limit of this range, a threshold value for identifying the silkscreen printed part from the other part is obtained. Then, with the use of this value as an index, the given image data is binarized.

Then, in Step S3, from the thus-obtained binarized image data, image data of the silkscreen printed part is searched for. As a result, it is possible to obtain a position of the silkscreen printed part within the area defined by the above-mentioned silk inspection window.

In Step S4, as shown in FIG. 5, a component inspection window W1 is set within an area inner than the thus-obtained positions of the silkscreen printed parts 210 (specifically, within the inscribed rectangular area thereof). After that, image data defined by this component inspection window W1 is made to undergo analysis by means of image processing, and thereby, mounted electronic component appearance inspection is carried out. Specifically, in this appearance inspection, it is determined whether or not the electronic component 100 itself is positively mounted at a proper position, whether or not soldering between the electrodes 110 and the lands 200 is finished properly, or such. Thus, according to the embodiment of the present invention, it is possible to effectively avoid adverse influence of the silkscreen printed parts otherwise occurring, and as a result, it is possible to carry out mounted electronic component appearance inspection satisfactorily.

It is preferable that the above-mentioned Steps S1 through S4 are carried out by a computer according to instructions described in a computer program, automatically.

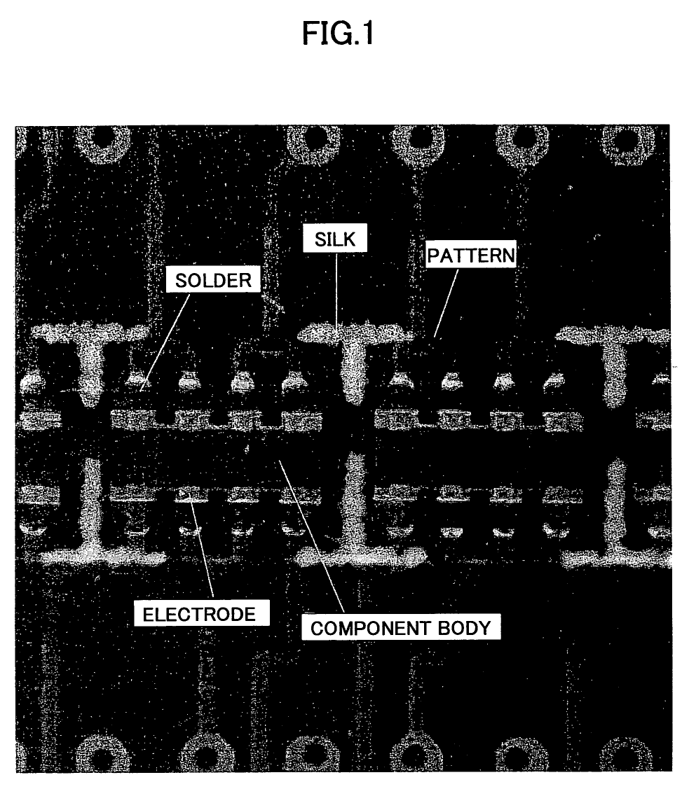

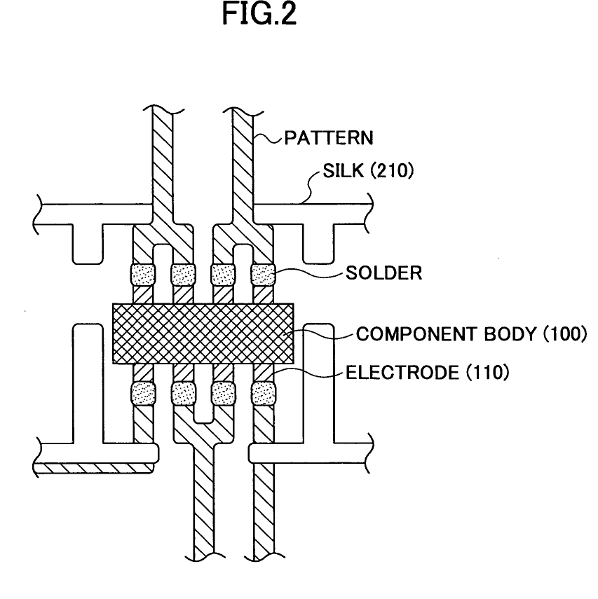

As the image data used for the above-mentioned steps of obtaining the position of the silkscreen printed part in Steps S2 and S3, brightness data of a monochrome image, color data of a color image, or both of the brightness data and the color data may be applied. Other than the above-mentioned example, a pattern matching technology or such may be applied to identify the silkscreen printed part from the given photographed image. Specifically, with the use of the pattern matching technology, by which a pattern shape (such as that shown in FIG. 1 or 2) appearing in the photographed image of the printed circuit substrate may be identified, the silkscreen printed part 210 may be identified, and therefrom, the position thereof may be obtained. In this case, by photographing the printed circuit substrate three-dimensionally, it is possible to utilize features of a three-dimensionally configuration of the surface of the printed circuit substrate including a height (thickness/depth) component, on which the silkscreen printed part 210 is printed, for identifying the same. As a result, it is possible to obtain the position of the silkscreen printed part 210 further accurately in this case.

Further, by appropriately combining these identification indexes, it is possible to carry out the detection of the position of the silkscreen printed part 210 more effectively. Specifically, the printed circuit substrate may be photographed two-dimensionally or three-dimensionally; and then, data of a two-dimensional or three-dimensional topographic configuration of the printed circuit substrate appearing in the thus-taken image, as well as brightness and/or color data obtained from the same image, may be totally analyzed. As a result, it is possible to obtain the position of the silkscreen printed part 210 printed on the printed circuit substrate more accurately.

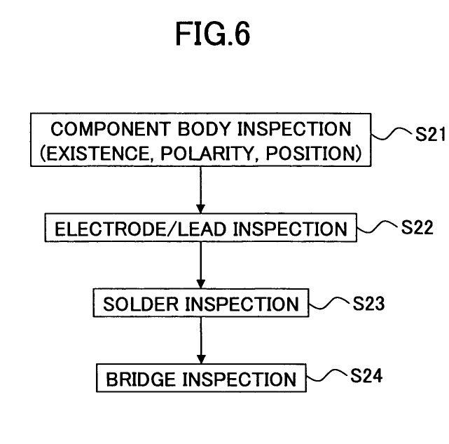

With reference to FIGS. 6 through 9B, an embodiment of the present invention is described in further detail.

FIG. 6 shows a general configuration of a printed circuit substrate appearance inspection process according to an embodiment of the present invention.

In this process, first, inspection is made to verify whether each electronic component is mounted on a printed circuit substrate positively, whether a polarity of each electronic component is correctly set, whether each electronic component is located correctly, and so forth, in Step S21. Then, in Step S22, inspection is made to verify whether electrodes or leads of each electronic component do not have any defect. After that, in Step S23, inspection is made to verify whether soldering connection between an electrode of each electronic component and a land of an electrically conductive pattern of the printed circuit substrate is done properly. Then, in Step S24, inspection is made to verify whether short-circuiting between electrodes or leads, i.e., bridging, or such, does not occur (bridge inspection). The order of Steps S21 through S24 may be changed arbitrarily.

‘A method of extracting a silkscreen printed part formed on a printed circuit substrate and setting a component inspection window avoiding the silkscreen printed part’ according to the present invention may be applied to the ‘component body inspection’ in Step S21 mentioned above. There, as described above, from a photographed image of the printed circuit substrate, a position at which the silkscreen printed part is formed is detected, and, the component inspection window is set avoiding the silkscreen printed part. Then, on an image part defined by the component inspection window, image data analysis is carried out. Therefrom, erroneous soldering causing short-circuiting between electrodes, or such, is searched for, at high accuracy.

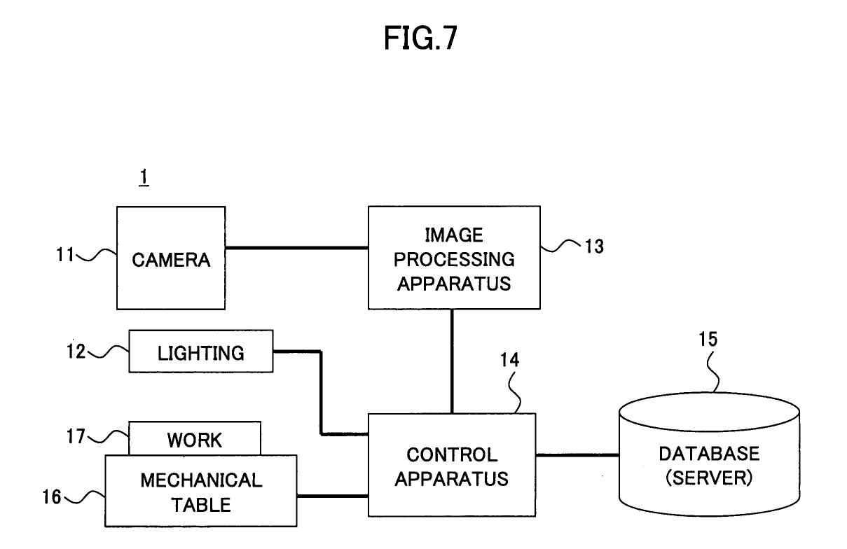

FIG. 7 shows a block diagram of an appearance inspection apparatus in one example carrying out the above-described printed circuit substrate appearance inspection process. As shown, the appearance inspection apparatus according to one embodiment of the present invention includes a mechanical table 16 on which a product (work) 17 of a printed circuit substrate to be inspected (to-be-inspected product) is placed; a lighting device 12 lighting the printed circuit substrate 17 thus-placed on the mechanical table 16; and a camera 11 photographing (or taking a photo of) the thus-lit printed circuit substrate 17.

A positional relationship between the mechanical table 16 and the camera 11, as well as a positional relationship between the mechanical table 16 and the printed circuit substrate 17 as the to-be-inspected product placed on the mechanical table 16 are set according to predetermined standards. As a result, as long as the printed circuit substrate 17 manufactured according to predetermined design requirements is placed on the mechanical table 16 according to the above-mentioned standard, it is possible to estimate a position of each electronic component mounted on the printed circuit substrate 17 in a photographed image obtained from photographing the printed circuit substrate 17 by means of the camera 11.

Further, the appearance inspection apparatus in the present embodiment includes a control apparatus 14 controlling the lighting device 12 and the mechanical table 16; an image processing apparatus 13 carrying out control of the camera 11 as well as the above-mentioned mentioned binarization of image data taken by the camera 11, or other necessary operations; and a database 15 storing design data of each of the to-be-inspected products to be handled by this appearance inspection apparatus, and other necessary data/information.

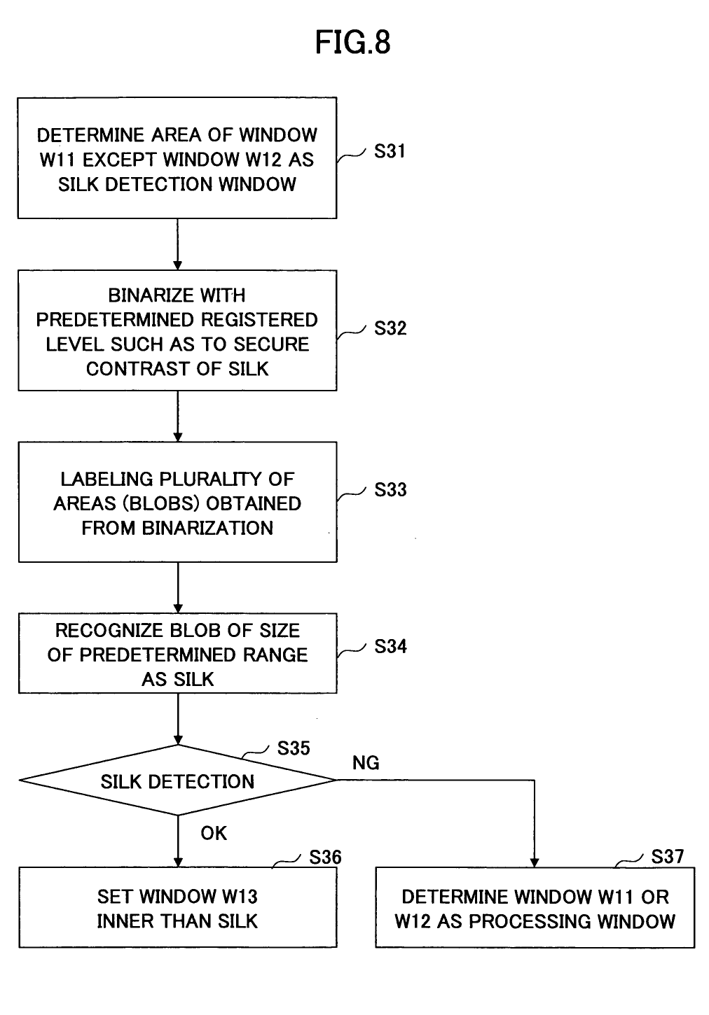

The control apparatus 14 first calls necessary information from the database 15 concerning the relevant to-be-inspected product (work) 17. Then, the control apparatus 14 controls the lighting device 12 and the mechanical table 16, and sends a signal to the image processing apparatus 13. Therewith, the image processing apparatus 13 sends a signal to the camera 11 so that the camera 11 takes a photograph of the to-be-inspected product 17 placed on the mechanical table 16, and thus obtains the image thereof. The thus-obtained image is then sent to the image processing apparatus 13, which then processes it according to a predetermined manner. The thus-processed image data is then sent to the control apparatus 14. The control apparatus 14 then carries out the inspection process such as that described above with reference to FIG. 6 or will be described in further detail with reference to FIGS. 8, 9A and 9B, and the thus-obtained inspection result is displayed on a monitor device of the control apparatus 14 itself, or a monitor device of the image processing apparatus 13. On the other hand, the inspection result is stored in a storage device of the control apparatus 14 if necessary. In the database 15, the information necessary for the inspection of each electronic component mounted on the printed circuit substrate 17 and the printed circuit substrate itself is previously registered, and, is applied to the above-mentioned inspection procedure.

As the above-mentioned photographing means, the camera 11 should not be necessarily required. Any other device may be applied for the same purpose as long as it has a function of taking image information of the to-be-inspected product. Further, the example shown in FIG. 7 is configured so that the mechanical table 16 is controlled and thereby the to-be-inspected product is moved appropriately, and thus, an image at an arbitrary position of the printed circuit substrate 17 can be taken by the camera 11. However, other than this manner, another manner may be applied instead such that the table 16 is fixed, while rather the camera 11 photographing the to-be-inspected product 17 is moved appropriately, so that an image at an arbitrary position of the printed circuit substrate 17 can be taken by the camera 11.

Further, the image processing apparatus 13, the control apparatus 14 and the database 15 may be integrated into a unit apparatus.

In the above-described configuration, the control apparatus 14 acts as ‘a part defining a predetermined inspection area in an image of a printed circuit substrate including a component mounted on the printed circuit substrate’ and ‘a part carrying out appearance inspection concerning the component by analyzing image data of the thus-defined inspection area’. Similarly, the control apparatus 14 also acts as ‘a part detecting a printed substrate pattern part around the component on the printed circuit substrate, and ‘a part defining the predetermined inspection area avoiding the detected printed substrate pattern part’. Other than this manner, the image processing apparatus 13 instead may act as ‘a part defining a predetermined inspection area in an image of a printed circuit substrate including a component mounted on the printed circuit substrate’ and ‘a part carrying out appearance inspection concerning the component by analyzing image data of the thus-defined inspection area’

With reference to FIGS. 8, 9A and 9B, an operation flow of a method of detecting a position at which a silkscreen printed part is formed, and setting a component inspection window avoiding the silkscreen printed part is described next.

First, in Step S31, an area of a window W11 (rectangular area), previously registered, configured to include silkscreen printed parts 210 around an electronic component 100 is set in a photographed input image of a printed circuit substrate including the electronic component 100. Then, from the area W11, a minimum area (circumscribed rectangular area), of a window W12, including lands 200 formed on the printed circuit substrate around the electronic component 100, is removed (see FIG. 9B). Then, a thus-obtained area (W11-W12) is set as a silk detection window.

It is noted that deign data of the printed circuit substrate as the to-be-inspected product is previously stored in the data base 15. The control apparatus 14 refers to this deign data, and thereby, recognizes, within a component mounting positional error range, a position at which each electronic component is mounted, from the image of the printed circuit substrate placed on a predetermined position of the mechanical table 16, photographed by the camera 11 set at a predetermined position. As a result, the control apparatus 14 can properly determine the area including the silkscreen printed parts 210 around the relevant electronic component 100, or set the predetermined window defining the circumscribed rectangular area of the lands 200 corresponding to the electrodes 110 of the relevant electronic component 100, as shown in FIGS. 9A and 9B,

In Step S32, the image data within the area of above-mentioned silk detection window (W11-W12) is binarized with the use of a threshold value, previously registered to secure a contrast of the silkscreen printed parts 210. In other words, as described above, the threshold value which is previously obtained based on data obtained from actual measurement or such, which is a value of the outer limit of a range which a brightness value of an image of the silkscreen printed part may have. Then, with the use of this value as an index, the given image data is binarized.

An appropriate value of the above-mentioned threshold value for the binarization may be instead obtained from the above-mentioned photographed input image data automatically for each particular product. Specifically, by analyzing image data around the relevant electronic component within the photographed image of the printed circuit substrate, the above-mentioned binarization threshold value may be obtained individually. Actually, positions at which the silkscreen printed parts 210 and the lands 200 are formed on the printed circuit substrate respectively and a position at which each electronic component 100 is mounted thereon conform to predetermined standards previously determined for each particular type of the printed circuit substrate. Therefore, these positions are expected to be the same as those according to the standards within a range of positional error which may occur when they are formed or mounted on the substrate actually. Accordingly, by analyzing the image data around the standard mounting position of the relevant electronic component 100, it is possible to obtain data of color and/or brightness of the silkscreen printed parts 210 or the lands 200 concerning the electronic component 100 by means of estimation. Then, with the use of the data thus obtained, it is possible to obtain the threshold value for identifying the silkscreen printed parts 210.

Then, labeling is carried out for each of a plurality of candidates for the silkscreen printed parts, thus obtained as a result of the binarization in Step S32, in Step S33. Then, for each of these candidates thus labeled, determination is carried out whether or not a previously registered reference size requirement for the silkscreen printed part is satisfied. Then, when one which satisfies the reference size requirement is found out from among these candidates, it is recognized actually as being the silkscreen printed part 210 in Step S34. For the detection of the silkscreen printed part 210, other than the above-mentioned method of determining with respect to the size of each candidate, another method may also be applied in which a peripheral length or such of each candidate is measured and is used as a key for identifying the silkscreen printed part 210.

The binarization is not necessary to be carried out, and, instead, identification of the silkscreen printed part 210 may be carried out applying a well-known pattern matching technology or such, for identifying the silkscreen printed part 210 from among the candidates obtained from the photographed input image.

After the silkscreen printed part 210 is thus detected (OK in Step S35), a component inspection window W13 is generated in a range inside from the thus-detected silkscreen printed parts 210, i.e., on the side of the electrodes 110/lands 200 (inscribed rectangle), in Step S36. The thus-generated component inspection window W13 includes the electrodes 110, the lands 200, but does not include the silkscreen printed parts 210, as shown in FIG. 9B, since it is generated in the manner to avoid the silkscreen printed parts 210 detected in Steps S34 and S35. After that, actual processing of appearance inspection of the electronic component 100 is carried out on the image data in the area defined by the component inspection window W13.

By analyzing the image data within the thus-set component inspection window W13, upon carrying out detection of or search for a component edge of the electronic component 100, it is possible to carry out the detection/search, accurately without adverse affect of the silkscreen printed parts 210. As a result, it is possible to carry out the appearance inspection of the electronic components mounted on the printed circuit substrate, accurately.

When no silkscreen printed part has been detected in Steps S34 and S35 (NG), the above-mentioned window W11 including the silkscreen printed parts or the window W13 of the minimum area including the lands 200 is applied as the component inspection window W13 finally.

The above-mentioned detecting of or search for the component edge of the electronic component 100 means, for example, detection of top and bottom end positions of the component body 100 in the example of FIG. 2. By thus carrying out the edge detection for the component body 100, an inspection window may be then set with respect to the thus-detected top and bottom end positions of the component body 100, for the purpose of determining whether or not soldering of the electronic component 100 is finished properly, or such. As a result of the inspection window thus being set after the top and bottom end positions of the component body 100 are positively detected, it becomes possible to then positively detect the positions of the electrodes 100 at which soldering should have been actually carried out as mentioned above. As a result, it is possible to positively carry out verification of soldering finish (including detection of bridging which means short-circuiting between adjacent electrodes) accurately.

The above-mentioned edge detection for the component body 100 may be carried out, the same as the above-mentioned detection of the silkscreen printed parts, by binarizing image data with the use of color/brightness data or such of the component body 100 as an index; and searching the thus-binarized image data for an area satisfying a predetermined size requirement from among candidates thereof identified by the binarization. Also in this case, an edge detection window may be previously set. In this case, if the silkscreen printed parts 210 were included within the area defined by this edge detection window, they would act as noise in the image data, and thereby, accurate detection of the positions of the edges (top and bottom ends) of the component body 100 could not be achieved. By applying the present invention to extract the silkscreen printed parts 210 and generate the inspection window avoiding them, the above-mentioned problem may be solved, and thus, accurate edge detection can be achieved.

The operations described above with reference to FIGS. 8, 9A and 9B may be achieved in the following manner: For example, a CPU (not shown) included in the control apparatus 14 or the image processing apparatus 13 reads a program of ‘detecting silkscreen printed parts and setting a component inspection window avoiding the silkscreen printed parts’ according to the present invention stored in a predetermined recording medium (such as a CD-ROM), or downloads the same program from an external server via a communication network such as the Internet, a LAN or such. Then, the CPU writes the thus-obtained program in a hard disk device (not shown) or such also included in the control apparatus 14 or the image processing apparatus 13. After that, the CPU reads instructions of this program in sequence and executes the same, and as a result, automatic execution of the operations described above with reference to FIGS. 8, 9A and 9B is achievable.

The above-mentioned silkscreen printed part (generally referred to simply as “silk”) is formed on a printed circuit substrate as mentioned above for the purpose of enabling a human being to recognize various sorts of information with the naked eyes therefrom. As possible applications thereof, for example, the followings may be cited:

indication of an electronic component mounting position;

indication of an electronic component's name;

indication of an electronic component's polarity;

indication of an electronic component's pin number;

indication of a drawing number (to which a barcode may be added); and

indication of an area inhibiting any electronic components from being mounted.

Further, as an alternative of the silkscreen printed part, the following may be applied, and, for this alternative of the silkscreen printed part, the present invention may also be applied in the same way as that for the silkscreen printed part itself described above.

For example, in a case where only a single semiconductor device is mounted, and thus, contents required to be drawn are very few, a drawing number or such may be drawn on a printed circuit substrate during a wiring pattern forming process. In such a case, necessary information is drawn on the printed circuit substrate with the use of electrically conducive material, originally used for forming a wiring pattern. Thereby, it is possible to omit a silkscreen printed part forming process.

A term ‘printed substrate pattern part’ is used in the specification and claims of the present application, to mean a concept which may widely include various sorts of indication having visuality drawn on a surface of a printed circuit substrate, such as those not only including the above-mentioned silkscreen printed part but also including the above-mentioned alternative thereof with the use of the wiring pattern material or such. That is, according to the present invention, the printed substrate pattern part such as the silkscreen printed part, a wiring pattern as the alternative thereof or such formed on a printed circuit substrate is detected, and a predetermined inspection area is set avoiding the thus-detected printed substrate pattern part. Thereby, erroneous identification or such otherwise occurring due to the printed substrate pattern part can be positively avoided.

Further, the present invention is not limited to the above-described embodiments, and, variations and modifications may be made without departing from the basic idea of the present invention claimed below.

The present application is based on Japanese priority application No. 2004-223927, filed on Jul. 30, 2004, the entire contents of which are hereby incorporated herein by reference.

What is claimed is:

1. A printed circuit substrate appearance inspection method comprising:
an inspection area defining step defining a predetermined inspection area in an image of a printed circuit substrate including a component mounted on the printed circuit substrate; and
an appearance inspection step carrying out appearance inspection of the component by analyzing image data of the thus-defined inspection area, wherein:
said inspection area defining step comprises the steps of;
detecting a printed substrate pattern part around the component on the printed circuit substrate; and
defining the predetermined inspection area avoiding the thus-detected printed substrate pattern part.

2. The printed circuit substrate appearance inspection method as claimed in claim 1, wherein:
said predetermined inspection area comprises a rectangular area, and is defined within an inscribed rectangular area with respect to the thus-detected printed substrate pattern part.

3. The printed circuit substrate appearance inspection method as claimed in claim 1, wherein:
said inspection area defining step comprises the steps of:
defining a first area including the printed substrate pattern part concerning the component;
defining a second area including lands provided for electrodes of the component;
defining a third area, avoiding said second area, within said first area;
detecting, for the third area, the printed substrate pattern part, with the use of, as an index, a predetermined characteristic of image concerning the printed substrate pattern part; and
defining the predetermined inspection area avoiding the thus-detected printed substrate pattern part.

4. The printed circuit substrate appearance inspection method as claimed in claim 3, wherein:
the first and second areas, as well as the predetermined inspection areas, comprise rectangular areas, respectively; and
the predetermined inspection area is defined within an inscribed rectangular area with respective to the detected printed substrate pattern part.

5. The printed circuit substrate appearance inspection method as claimed in claim 1, wherein:
said step of detecting a printed substrate pattern part around the component on the printed circuit substrate is carried out with the use of an index comprising at least one of a color, brightness and a shape appearing on the printed circuit substrate.

6. The printed circuit substrate appearance inspection method as claimed in claim 1, wherein:
said step of detecting a printed substrate pattern part around the component on the printed circuit substrate is carried out by means of pattern marching.

7. A program causing a computer to carry out printed circuit substrate appearance inspection, comprising instructions to cause the computer to execute:
an inspection area defining step defining a predetermined inspection area in an image of a printed circuit substrate including a component mounted on the printed circuit substrate; and
an appearance inspection step carrying out appearance inspection of the component by analyzing image data in the thus-defined inspection area, wherein:
said inspection area defining step comprises;
detecting a printed substrate pattern part around the component on the printed circuit substrate; and
defining the predetermined inspection area avoiding the thus-detected printed substrate pattern part.

8. The program as claimed in claim 7, wherein:
said predetermined inspection area comprises a rectangular area, and the program further comprises instructions to cause the computer to execute the step of defining the predetermined inspection area within an inscribed rectangular area with respect to the detected printed substrate pattern part.

9. The program as claimed in claim 7, wherein:
said inspection area defining step comprises the steps of:
defining a first area including the printed substrate pattern part concerning the component;
defining a second area including lands provided for electrodes of the component;
defining a third area, avoiding said second area, within said first area;
detecting, for the third area, the printed substrate pattern part, with the use of, as an index, a predetermined characteristic of image concerning the printed substrate pattern part; and
defining the predetermined inspection area avoiding the thus-detected printed substrate pattern part.

10. The program as claimed in claim 9, wherein:
the first and second areas, as well as the predetermined inspection areas, comprise rectangular areas, respectively; and
the program comprises instructions to cause the computer to execute the step of defining the predetermined inspection area within an inscribed rectangular area with respect to the detected printed substrate pattern part.

11. The program as claimed in claim 7, comprising instructions such that:
said step of detecting a printed substrate pattern part around the component on the printed circuit substrate is carried out with the use of an index comprising at least one of a color, brightness and a shape appearing on the printed circuit substrate.

12. The program as claimed in claim 7, comprising instructions such that:
said step of detecting a printed substrate pattern part around the component on the printed circuit substrate is carried out by means of pattern marching.

13. A printed circuit substrate appearance inspection apparatus comprising:
a part configured to define a predetermined inspection area in an image of a printed circuit substrate including a component mounted on the printed circuit substrate; and
a part configured to carry out appearance inspection of the component by analyzing image data in the thus-defined inspection area, wherein:
said part configured to define the predetermined inspection area comprises;
a part configured to detect a printed substrate pattern part around the component on the printed circuit substrate; and
a part configured to define the predetermined inspection avoiding the thus-detected printed substrate pattern part.

14. The printed circuit substrate appearance inspection apparatus as claimed in claim 13, wherein:
said predetermined inspection area comprises a rectangular area, and is defined within an inscribed rectangular area with respect to the thus-detected printed substrate pattern part.

15. The printed circuit substrate appearance inspection apparatus as claimed in claim 13, wherein:
said part configured to define the predetermined inspection area comprises:
a part configured to define a first area including the printed substrate pattern part concerning the component;
a part configured to define a second area including lands provided for electrodes of the component;
a part configured to define a third area, avoiding said second area, within said first area;
a part configured to detect, for the third area, the printed substrate pattern part, with the use of, as an index, a predetermined characteristic of image concerning the printed substrate pattern part; and
a part configured to define the predetermined inspection area avoiding the thus-detected printed substrate pattern part.

16. The printed circuit substrate appearance inspection apparatus as claimed in claim 15, wherein:
the first and second areas, as well as the predetermined inspection areas, comprise rectangular areas, respectively; and
the predetermined inspection area is defined within an inscribed rectangular area with respect to the detected printed substrate pattern part.

17. The printed circuit substrate appearance inspection apparatus as claimed in claim 13, wherein:
said part configured to detect the printed substrate pattern part carries out detecting of the printed substrate pattern part with the use of an index comprising at least one of a color, brightness and a shape appearing on the printed circuit substrate.

18. The printed circuit substrate appearance inspection apparatus as claimed in claim 13, wherein:
said part configured to detect the printed substrate pattern part carries out detecting of the printed substrate pattern part by means of pattern marching.
